(19) United States
(12) Patent Application Publication
(10) Pub. No.: US 2023/0019494 A1
(43) Pub. Date: Jan. 19, 2023

(54) DATA VERIFICATION METHOD AND APPARATUS, COMPUTER DEVICE, AND COMPUTER READABLE STORAGE MEDIUM

(71) Applicant: TENCENT TECHNOLOGY (SHENZHEN) COMPANY LIMITED, Shenzhen (CN)

(72) Inventors: Dongyan WANG, Shenzhen (CN); Maocai LI, Shenzhen (CN); Zongyou WANG, Shenzhen (CN); Hu LAN, Shenzhen (CN); Qucheng LIU, Shenzhen (CN); Yi LIU, Guangdong (CN)

(73) Assignee: TENCENT TECHNOLOGY (SHENZHEN) COMPANY LIMITED, Shenzhen (CN)

(21) Appl. No.: 17/948,390

(22) Filed: Sep. 20, 2022

Related U.S. Application Data
(63) Continuation of application No. PCT/CN2021/126744, filed on Oct. 27, 2021.

(30) Foreign Application Priority Data
Nov. 24, 2020 (CN) 202011332117.1

(51) Int. Cl. G06F 21/64; H04L 9/32

(52) U.S. Cl. CPC G06F 21/64; H04L 9/32

(57) ABSTRACT

A data verification method and apparatus, a computer device and a computer-readable storage medium are provided, and belong to the technical field of networks. The method includes the following steps: acquiring a data verification request; acquiring at least one set of first data from at least one data source; and verifying target data based on the at least one set of first data. According to the solution, by acquiring data having a production and life relationship with the target data, during data verification, the authenticity of the target data can be verified based on different dimensions and different production and life links.

### CROSS-REFERENCE TO RELATED APPLICATION(S)

This application is a continuation application of International Application No. PCT/CN2021/126744, filed on Oct. 27, 2021, which claims priority to Chinese Patent Application No. 202011332117.1, filed with the China National Intellectual Property Administration on Nov. 24, 2020, the disclosures of which are incorporated by reference in their entireties.

### FIELD

The present disclosure relates to the technical field of networks, and particularly relates to a data verification method and apparatus, a computer device and a computer-readable storage medium.

### BACKGROUND

A block chain is a decentralized database and is used for performing distributed storage on data.

### SUMMARY

Some embodiments of the disclose may provide a data verification method and apparatus, a computer device and a computer-readable storage medium. The method and the apparatus can verify the authenticity of target data based on data with different dimensions and in different production and life links. The technical solutions are as follows:

In one aspect, a data verification method may be provided, which is performed by a computer device, and the method includes: acquiring a data verification request, the data verification request including target data; acquiring at least one set of first data from at least one data source, the at least one set of first data and the target data having a target association relationship, and the at least one set of first data and the target data being data with different dimensions; and verifying the target data based on the at least one set of first data.

In one aspect, a data verification apparatus may be provided, and the apparatus includes: a request acquisition module, configured to acquire a data verification request, the data verification request including target data; a data acquisition module, configured to acquire at least one set of first data from at least one data source, the at least one set of first data and the target data having a target association relationship, and the at least one set of first data and the target data being data with different dimensions; and a verification module, configured to verify the target data based on the at least one set of first data.

According to one aspect, a computer device may be provided, including one or more processors and one or more memories, the one or more memories storing at least one computer program, the at least one computer program being loaded and executed by the one or more processors to implement the following operations: acquiring a data verification request, the data verification request including target data; acquiring at least one set of first data from at least one data source, the at least one set of first data and the target data having a target association relationship, and the at least one set of first data and the target data being data with different dimensions; and verifying the target data based on the at least one set of first data.

According to one aspect, a computer-readable storage medium may be provided, storing at least one computer program, the at least one computer program being loaded and executed by a processor to implement the following operations: acquiring a data verification request, the data verification request including target data; acquiring at least one set of first data from at least one data source, the at least one set of first data and the target data having a target association relationship, and the at least one set of first data and the target data being data with different dimensions; and verifying the target data based on the at least one set of first data.

According to one aspect, a computer program product may be provided, the computer program product including computer instructions, the computer instructions being stored in a computer-readable storage medium. A processor of a computer device reads the computer instructions from the computer-readable storage medium and executes the computer instructions to cause the computer device to perform the following operations. acquiring a data verification request, the data verification request including target data; acquiring at least one set of first data from at least one data source, the at least one set of first data and the target data having a target association relationship, and the at least one set of first data and the target data being data with different dimensions; and verifying the target data based on the at least one set of first data.

### BRIEF DESCRIPTION OF THE DRAWINGS

To describe the technical solutions of example embodiments of this disclosure more clearly, the following briefly introduces the accompanying drawings for describing the example embodiments. The accompanying drawings in the following description show only some embodiments of the disclosure, and a person of ordinary skill in the art may still derive other drawings from these accompanying drawings without creative efforts. In addition, one of ordinary skill would understand that aspects of example embodiments may be combined together or implemented alone.

FIG. 1 is a schematic structural diagram of a data verification system according to some embodiments.

FIG. 2 is a flowchart of a data verification method according to some embodiments.

FIG. 3 is a schematic hierarchical diagram of an association relationship between data according to some embodiments.

FIG. 4 is a schematic diagram of a data plane according to some embodiments.

FIG. 5 is a schematic diagram of a data source according to some embodiments.

FIG. 6 is a schematic diagram of a data verification method in the payment field and the tax field according to some embodiments.

FIG. 7 is a flowchart of data verification in the payment field and the tax field according to some embodiments.

FIG. 8 is a flowchart of data verification in the education field according to some embodiments.

FIG. 9 is a schematic structural diagram of a data verification apparatus according to some embodiments.

FIG. 10 is a schematic structural diagram of a terminal according to some embodiments.

FIG. 11 is a schematic structural diagram of a server according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict.

The terms “first”, “second”, and the like are used for distinguishing between same items or similar items of which effects and functions are basically the same. It is to be understood that, the “first”, “second”, and “nth” do not have a dependency relationship in logic or time sequence, and a quantity and an execution order thereof are not limited.

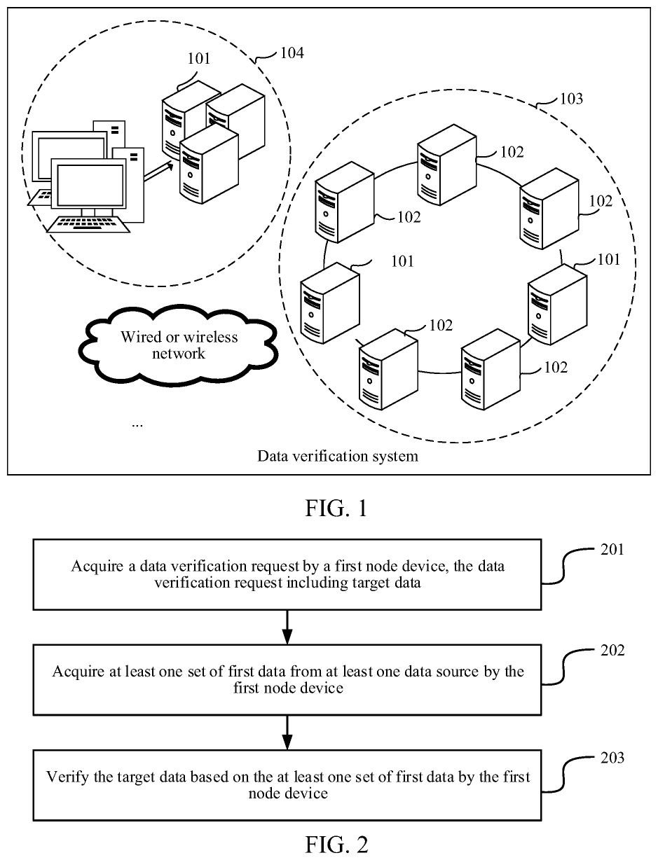

FIG. 1 is a schematic structural diagram of a data verification system according to some embodiments. As shown in FIG. 1, the data verification system includes a plurality of first node devices 101 and a plurality of second node devices 102.

The first node devices 101 have a data verification function and are capable of acquiring multi-dimensional data and verifying the target data. The first node devices 101 may be node devices corresponding to institutions needing data verification, such as the node devices of the institutions like a tax institution, a loan institution and an insurance institution. In some embodiments, the first node devices 101 are node devices of third-party institutions for performing data verification. In some embodiments, multi-dimensional data is provided to data verification parties, namely the first node devices 101, by a plurality of data sources; and after data verification is completed, the first node devices 101 will transmit verification results to the demand party like the tax institution, the loan institution and the insurance institution.

The plurality of second node devices 102 are node devices of different operation entities or personal users respectively and are capable of initiating data verification request. For example, the second node device 102 belonging to a certain merchant initiates a data verification request to the node device of the tax institution; and the node device belonging to a certain education institution initiates a data verification request to the node device of the third-party institution for performing data verification.

The first node devices 101 and the second node devices 102 can be any computer device, such as a smart phone, a tablet computer, a notebook computer, a desktop computer, an independent physical server, a server cluster composed of a plurality of physical servers, or a distributed system, a cloud server and the like.

As shown in FIG. 1, the data verification system can include at least two subsystems. One subsystem can be constructed in each of different production and life fields, for example, the node devices in the tax field form one subsystem, and the node devices in the insurance field form one subsystem. The above explanation of a subsystem division method is merely an exemplary explanation, and this embodiment has no limit on which dimension is taken as the basis and how to divide the subsystem. In some embodiments, the subsystem can further include a smaller unit, and this embodiment is not limited thereto. In some embodiments, the subsystem is a block chain system, such as a subsystem 103 in FIG. 1, each first node device 101 and each second node device 102 included in the subsystem are node devices on the block chain. In some embodiments, the subsystem is a non-block chain system, such as a subsystem 104 in FIG. 1. In some embodiments, the first node device 101 in the subsystem 104 has an authority to performing reading, query and other operations on the data in the block chain. In some embodiments, the first node devices 101 can also be capable of storing the data to the block chain system.

At present, when applying block chain technology for data storage, it can only be ensured that the data stored on all the node devices in the block chain system are consistent, but the authenticity of the stored data cannot be guaranteed, and therefore there is a possibility that the data stored on the chain may be junk data.

The data verification method provided in the embodiments can be applied to various fields and can be combined with various scenarios of production and life, such as supply chain production, payment scenarios, the tax field, due diligence, notarization and the education field. According to the technical solution provided the embodiments, data with different dimensions, various fields and different time periods are combined for data verification, multi-dimensional data verification loops are formed, verification storage of all the data verification loops can be verified mutually, and an interconnected verification storage with higher complexity is formed, thus it is guaranteed that the data verification result is reliable, and the credibility of the data in the network is improved.

FIG. 2 is a flowchart of a data verification method according to some embodiments. The method can be applied to the above-mentioned implementation environment. In some embodiments, the data verification method includes the following operations:

201. Acquire a data verification request by a first node device, the data verification request including target data.

The target data is data from any production and life field, for example, the target data is contract data, tax data, payment data, supply chain production data and the like. The target data corresponds to one piece of index information, for example, the index information is a contract number, a serial number of a transaction, a certificate number of a user, a production batch of a product and the like.

In some embodiments, the user or the operation entity can initiate the data verification request by a second node device. For example, in a loan scene, a borrower needs to provide effective qualification data for the loan institution. The qualification data includes data for proving the repayment capability of the borrower, such as transaction flow data for purchasing production materials and selling products and asset and debt data of the borrower, but is not limited thereto. In some embodiments, the node device of the borrower is treated as the second node device to transmit the data verification request to the first node device, the data verification request including the qualification data provided by the borrower; the first node device is configured to verify the effectiveness of the qualification data and provide a certificate that the qualification data is effective data, and therefore the borrower can complete borrowing based on the certificate. The first node device is the node device of the loan institution, or the first node device is the node device of an institution providing data verification service.

In some embodiments, the data verification request is initiated by the node device of the loan institution, namely the loan institution is the second node device. The node device of the borrower transmits a loan request to the node device of the loan institution, namely the second node device; the loan request carries loan information and the qualification data of the borrower; the second node device generates the data verification request in response to the loan request; the target data included in the data verification request is the qualification data of the borrower; and the second node device transmits the data verification request to the node device of the institution providing the data verification service, namely the first node device. In some embodiments, the first node device and the second node device both belong to the loan institution. The second node device is configured to process the loan request, generate the data verification request after receiving the loan request, and transmit the data verification request to the first node device for performing data verification.

202. Acquire at least one set of first data from at least one data source by the first node device.

The data source is a public chain, a private chain, a consortium chain and the like, or the data source is a database of government agencies, enterprises and the like. A target association relationship is included between the at least one set of first data and the target data, moreover, the at least one set of first data and the target data are data with different dimensions, and the target association relationship is a production and life relationship. In some embodiments, the at least one set of first data includes original data, data verification storage (hash) and the like generated in each production and life link. In some embodiments, the at least one set of first data is the data acquired by performing data processing on the original data. For example, the first node device obtains original data from the data source and then performs data processing on the original data to obtain the at least one set of first data. In some embodiments, the first data carries at least one digital signature, the digital signature belonging to at least one institution, and the digital signature is used for indicating the credibility of the first data. For example, in case that the first data carries a digital signature of a certain institution, the credibility of the first data is relatively high.

In some embodiments, the target association relationship includes a natural dimension relationship and a human production dimension relationship. For example, the relationships such as time, space and physical and chemical reactions belong to the natural dimension relationship, and the supply chain relationship, the identity relationship, the sovereign relationship, the education relationship and the like belong to the human production dimension relationship.

For example, the target data is contract data, and the index information of the target data is the contract number, the acquired first data includes the contract number, and the first data is data in the payment field, data in the tax field and the like associated with the contract data. For another example, in case that the target data is product sales data, and the index information of the target data is a product production batch, the first data is upstream and downstream data associated with the product production batch, such as raw material purchase data and product production data. And for yet another example, in case that the target data is payment data of a certain user, and the index information of the target data is a certificate number of the user, the first data is the income data, loan data and the like of the user.

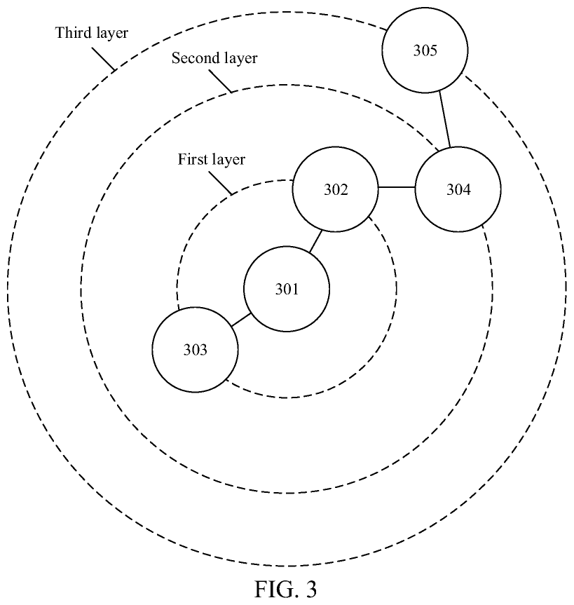

In some embodiments, the production and life relationship between the target data and the first data includes a plurality of hierarchies. FIG. 3 is a schematic hierarchical diagram of an association relationship between data according to some embodiments. As shown in FIG. 3, target data 301 is directly associated with data 302 and data 303 of a first relationship layer and is indirectly associated with data 304 of a second relationship layer and data 305 of a third relationship layer. In some embodiments, each piece of data corresponds to a confidence, the confidence changes of the data of different hierarchies will influence the confidence of the associated data, for example, the confidence changes of the data 302, the data 303, the data 304 and the data 305 will influence the confidence of the target data 301.

The acquired first data is data authorized to be exposed to the first node device. In case that the user requests the first node device to perform data verification, which data is authorized to the first node device is added in the data verification request. For example, an identifier of the data source to which the authorized data belongs, an identifier of the field to which the authorized data belongs and the like are added in the data verification request. The user can also authorize data in a certain time period, but is not limited thereto.

In some embodiments, in case that the data verification request does not include information of the authorized data, the first node device requests data authorization from the user in case that acquiring the first data. This embodiment of this application has no limit on data authorization manner. In some embodiments, the first node device can acquire the first data in combination with a privacy computing mode in order to avoid privacy data leakage of individuals or institutions in the data verification process.

In some embodiments, the first node device acquires data through a smart contract, and the smart contract is used for providing an association relationship between the to-be-verified data and the first data. The smart contract is used for determining to acquire data having which association relationship with the target data, or the smart contract is used for determining which field the acquired data comes from, and this embodiment of this application has no specific limit on this.

In some embodiments, the data verification request includes a contract identifier. In case that the second node device generates the data verification request, the smart contract called for this data verification is determined based on the request type of the data verification request, the index information of the to-be-verified data and the like, and the contract identifier of the smart contract is added into the data verification request.

In some embodiments, in a loan scene, the second node device is configured to determine the smart contract called for this data verification based on the request type being loan qualification data verification and index information of to-be-verified data, certainly, the called smart contract can be determined based on indexes such as loan amount and loan type, and this embodiment of this application has no limit on this. The smart contract is a public smart contract in a data verification system, or the smart contract is a smart contract belonging to a certain loan institution, but is not limited thereto.

In some embodiments, the first node device is configured to acquire the at least one set of first data based on the smart contract indicated by the contract identifier in response to the data verification request including the contract identifier. The first node device executes a data verification operation in response to the received data verification request. The data verification operation will trigger the smart contract to run, and then the at least one set of first data is acquired by the smart contract. The smart contract corresponding to the contract identifier is triggered by the first node device to run in a block chain system according to the contract identifier. The smart contract is determined based on the contract identifier in the data verification request, and then the first data is acquired based on the smart contract, so that the first data can be efficiently acquired.

In some embodiments, the smart contract further includes definition of layer of the association relationship between the data. The association relationship layer shown in FIG. 3 is taken as an example, the first node device can obtain first data of which the association relationship with the target data belongs to the first layer to the third layer, and it is ensured that the acquired first data is closely related to the target data

In some embodiments, the first node device is configured to determine the smart contract called by the data verification in response to the data verification request not including the contract identifier of the smart contract. The first node device is configured to acquire a request type of the data verification request and the index information of the target data in response to the data verification request not including a contract identifier, and acquire the at least one set of data based on the request type and the smart contract corresponding to the index information. The process of determining the smart contract called for this data verification by the first node device is similar to the process of determining the smart contract called for this data verification by the second node device, and no redundant description is made here. In case of no contract identifier of the smart contract, the smart contract is determined based on the request type and the index information, the first data can be acquired based on the smart contract, and thus the acquiring mode of the first data is expanded.

203. Verify the target data based on the at least one set of first data by the first node device.

In some embodiments, the first node device is configured to match each set of first data with the target data, and determine a verification result corresponding to each set of first data, and the verification result is that the verification is passed or the verification is failed. In case that the verification result corresponding to a certain set of first data is that the verification is passed, the target data is credible for this set of first data; and in case that the verification result corresponding to a certain set of first data is that the verification is failed, the target data is not credible for this set of first data. By acquiring the verification result corresponding to each set of first data, the target data can be verified based on the verification result, and thus the verification efficiency is improved.

In some embodiments, the verification result is represented in the form of confidence. The first node device is configured to verify the target data based on at least one type of first data to obtain the confidence of the target data. The confidence is used for representing the credibility of the data, can also be referred to as the credibility, the validity, the weight and the like of the data, and can be represented as a probability value.

In some embodiments, the confidence is identified in a syntax element or index and the like, and is configured in positions of a field header or a block head and the like of the data.

For example, the confidence is set in the data as a syntax element of Trust base index. In case that the target data is subsequently applied to data verification, the credibility of the target data is determined based on the value of the confidence, such as the index.

In some embodiments, the confidence is distinguished based on a target association relationship, namely the production and life relationship. The confidence determined based on different production and life relationships are identified as different syntax elements.

For example, in case that the target data is production data, the target data is verified based on data of a raw material supplier to obtain a confidence, and the confidence is identified as Supplier base index; or the target data is verified by the contract data to obtain a confidence, and the confidence is identified as Contract base index.

In some embodiments, the confidence has conductivity. The conductivity refers to that in case that the confidence of the data or data source referenced by a certain confidence changes, the acquired certain confidence will be influenced.

For example, data in a data source A is used for acquiring the confidence of target data S in a certain time period, the confidence of the data in the data source A is X at the moment, and the confidence of the target data S acquired based on the data in the data source A is M; in another time period, the data in the data source A is confirmed as false data, at the moment, the confidence of the target data S will be influenced, and the data verification node device is configured to determine the confidence of the target data S again based on a credible data source. That is, the confidence corresponding to the associated data form a confidence plane; in case of a confidence defect in the current confidence plane, that is, a certain data or data source is counterfeited, the data involved in the confidence plane needs to be subjected to confidence evaluation according to a credible data source, and in case that all the data involved in the confidence plane are counterfeited, the confidence plane is no longer available.

In some embodiments, acquiring the weight of the target data includes the following operations:

Operation 1. Determine the weight of the at least one set of data by the first node device.

The weight is used for indicating the credibility of the data, the larger the weight is, the higher the credibility of the data is, and the smaller the weight is, the smaller the credibility of the data is. The weight can also be called confidence, credibility, validity and the like.

In some embodiments, the weight of each piece of data is stored in the data source, and the first node device is configured to acquire the weight associated with the at least one set of first data from the at least one data source. The first node device is configured to acquire the weight stored in the data source from a block chain system. By directly acquiring the weight associated with the first data, the confidence of the first data is influenced by the first data.

In some embodiments, the weight of each piece of data is determined based on the confidence of the data verifier, the confidence of the data source, a digital signature carried by the data and other information.

For example, in case that the data uploading party is an institution with relatively high confidence, the weight of the data uploaded by the data uploading party is relatively large; and in case that the data uploading party is an institution with relatively low confidence, the weight of the data uploaded by the data uploading party is relatively small. The data carries the digital signature of a certain institution, and in case that the confidence of the institution is relatively high, the weight of the data is relatively large; and in case that the confidence of the institution is relatively low, the weight of the data is relatively small.

In some embodiments, different data sources correspond to different weights, so the first node device is configured to acquire the weight of the data source to which the at least one set of first data belongs, and determine the weight of the at least one set of first data based on the weight of the data source. For example, the weight of the data source is used as the weight of the at least one set of first data. The first node device is configured to acquire the weight stored in the data source from a block chain system. The weight of the data source is directly used as the weight of the first data, thus the confidence of the first data has a direct relationship with the data source.

In some embodiments, the first node device is configured to acquire a first weight associated with the at least one set of first data from the at least one data source, and acquire a second weight of the data source to which the at least one set of first data belongs. Then the first node device determines the weight of the at least one set of first data based on the first weight and the second weight. For example, the first node device performs weighted operation on the first weight and the second weight to obtain the weight of the at least one set of first data. By performing weighted summation on the first weight associated with the first data and the second weight of the data source, the weight of the first data is influenced by both the data source and other data associated with the first data, and thus the actual confidence of the first data can be accurately reflected.

The explanation of the method for determining the weight of the first data is an exemplary explanation of a possible implementation, and this embodiment of this application has no limit on which method is specifically adopted to determine the weight of the first data.

Step 2. Determine the confidence of the target data by the first node device based on the at least one set of first data and the weight of the at least one set of first data.

In some embodiments, the first node device is configured to perform weighted operation based on the matching data of the target data and each set of first data and the weight of each set of first data to obtain the confidence of the target data. The first node device is configured to determine the confidence based on various types of algorithms such as a linear algorithm and a log algorithm, and this embodiment of this application has no limit on this.

In some embodiments, the first node device applies at least two algorithms, and performs operation based on the matching data of the target data and each set of first data, the weights of each set of first data and other data to obtain confidence computed by each algorithm. During a target time period, verification results, namely confidence, acquired by various algorithms are accumulated, an error reporting rate corresponding to each algorithm is determined, and a target algorithm with the lowest error reporting rate is selected from the at least two algorithms, and the target algorithm is used for calculating in the subsequent data verification and target data confidence determination process.

In some embodiments, different algorithms are applied to data of different types and in different fields.

In some embodiments, the first node device is configured to determine the algorithm for data verification based on the target data or the acquired data. For example, data in the tax field and data in the education field adopt different algorithms to determine data verification results.

In some embodiments, a correspondence between information such as the data type and the data field and the algorithm is constructed, and the correspondence is stored in the first node device. During data verification, the first node device is configured to determine at least one algorithm for this data verification based on the correspondence.

For example, determining an algorithm adopted in the data verification process based on the target data is taken as an example, in case that the data type of the target data is the first type, or the target data belongs to the first field, it is determined that a first algorithm is applied to this data verification based on the correspondence, and based on the first algorithm, data such as the matching data of the target data and each set of first data and the weight of each set of first data are calculated.

In some embodiments, the first node device is configured to determine the algorithm adopted in the data verification process based on the first data. The first data acquired by the first node device can be data of different types and from different fields. For the first data of different types or different fields, the first node device can apply different algorithms to perform operation.

For example, the operation that the data of the second field corresponds to the second algorithm and the operation that the data of the third field corresponds to the third algorithm are taken as examples. The first data acquired by the first node device includes data from the second field and data from the third field, and the first node device is configured to determine to perform operation on the first data from the second field by the second algorithm and perform operation on the first data from the third field by the third algorithm based on the correspondence.

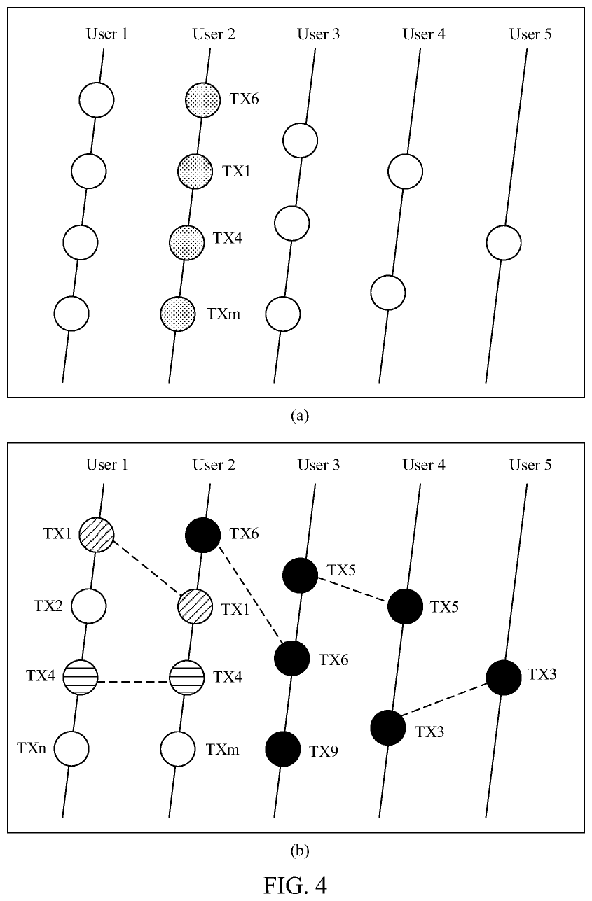

FIG. 4 is a schematic diagram of a data plane provided by an embodiment of this application, in this embodiment of this application, associated data in a block chain or other databases can form the data plane, and the confidence determination process is explained by taking the data plane shown in FIG. 4 as an example. After the user participates in a transaction, transaction data is generated based on the transaction. As shown in (a) of FIG. 4, in case of verifying the reference data of the user 2, the user declares that the transaction data associated with the reference data includes TX1, TX4, TX6 and TXm, and in case that the weight corresponding to each transaction is 1, the Trust base index (TSI) of the reference data is 4. For the same transaction, two parties of the transaction can generate transaction data respectively, the transaction data generated by the two transaction parties can be associated together for mutual verification; as shown in (b) of FIG. 4, as for the transaction TX1, the two transaction parties are the user 2 and the user 1, under the condition that the user 2 and the user 1 both authorize data to the opposite side, the transaction data generated by the user 2 and the transaction data generated by the user 1 in the transaction TX1 can be associated together; and as shown in (b) of FIG. 4, the TX1 corresponding to the user 2 and the TX1 corresponding to the user 1 are connected through a dotted line. Certainly, for data belonging to different transactions, an association relationship can also exist, as shown in (b) of FIG. 4, the associated transaction data is represented by the same texture, and the Trust associated index (TAI) can be introduced under this condition. The verification of certain data of the user 2 is taken as an example, for data of transaction TX6 declared by the user 2, other six pieces of data are associated, namely, data in FIG. 4 that has the same texture with TX6. As for data of transaction TX1, another one piece of data is associated; as for data of transaction TX4, another one piece of data is associated; as for data of transaction TXm, no associated data exist, and the Trust associated index of the reference data=(1+6)+(1+1)+(1+1)+1=12. The acquisition of the associated data is also authorized by the user, and unauthorized associated data cannot be acquired. In case that the user also provides two piece of verification data that are not stored online, such as paper invoices, the weight of each piece of verification data is 0.1 is taken as an example, and the weight of certain verified data is finally determined to be 12+0.1*2=12.2. In case that the data provided by the user is proved to be false data, namely, in case that the confidence changes, the confidence of the reference data is influenced. The confidence of the data provided by the user is determined based on the confidence of the user, and the higher the confidence of the user is, the higher the confidence of the data provided by the user is. For example, in (b) of FIG. 4, the confidence of the data TX1 declared by the user 2 is influenced by the confidence of the user 2. The confidence of the data can also be determined based on other modes, but is not limited thereto.

The description of the method for determining the confidence is only an exemplary description, and the embodiments are not limited as to which method is specifically adopted to determine the confidence.

In some embodiments, the first node device is configured to determine a risk level of the target data based on the confidence of the target data, and transmit prompt information corresponding to the risk level to an initiator of the data verification request, namely the second node device. Different confidence intervals correspond to different risk levels, and the confidence is negatively correlated with the risk level. For example, in case that the confidence is low, the risk level is high, the first node device transmits the prompt information corresponding to the higher risk level to the second node device, for example, in a loan qualification audit scene, the node device for data verification transmits the prompt information to the loan institution to prompt the loan institution that the risk of the current borrower is large, and the loan institution can determine whether to continue to process the subsequent loan service for the borrower based on the risk level. The first node device is configured to acquire the confidence of the target data from the block chain system, and acquire the corresponding prompt information from the block chain system based on the determined risk level. By transmitting the prompt information corresponding to the risk level to the initiator of the data verification request, whether the initiator has a risk can be prompted in time, thus the initiator can take corresponding measures based on the risk level in time, and the human-computer interaction efficiency is improved.

In some embodiments, the first node device is configured to determine a use priority corresponding to the target data based on the confidence of the target data, and the confidence is in positive correlation with the use priority. The first receiving device transmits the use priority corresponding to the target data to the initiator of the data verification request, namely the second node device, and the second node device determines which data is preferentially used based on the use priority of the data in the subsequent service processing process. By returning the use priority to the initiator of the data verification request, the initiator can adjust the data use sequence based on the use priority, thus the service processing efficiency of the initiator is improved.

According to the technical solution provided by this embodiment of this application, by acquiring data having a production and life relationship with the target data, such as data generated by upstream and downstream production links of the target data and these pieces of the data coming from different dimensions, during data verification, the authenticity of the target data can be verified based on different dimensions and different production and life links, so the data in the storage space has credibility and availability.

In some embodiments, the first node device is configured to store the target data and the confidence of the target data for subsequent data verification. During storing the target data, the first node device can perform data screening based on the confidence of the data, and data with high confidence is stored.

In some embodiments, the first node device is configured to store the target data and the confidence in a target storage space in an associated manner in response to the confidence of the target data being greater than a reference threshold. The reference threshold is set by a developer, but is not limited thereto. For example, the reference threshold is set to be a large numerical value to determine the authenticity of the data in the target storage space. The target storage space is configured to store data with a weight greater than the reference threshold in the at least one data source, namely, the data stored in the target storage space is credible data, and the data in the target storage space can form a credible data layer. The first node device is configured to acquire the reference threshold from the block chain system. By setting the target storage space, data verification can be quickly carried out based on the credible data in the target storage space, so that the verification efficiency and reliability are improved, and the resource occupation of data acquisition is reduced.

In some embodiments, the credible data layer can be applied to links such as data verification and data storage. In case that the credible data layer reaches a reference scale, in the processes of data verification, data storage and the like, the first node device can directly acquire related first data from the credible data layer to verify the authenticity of the to-be-verified or to-be-stored data. On one hand, the authenticity of other data is verified based on the credible data, it can be effectively guaranteed that the verification result is reliable, and on the other hand, there is no need to acquire data from other data sources, thus the data verification efficiency can be improved, and the operation amount in the data reading process is reduced. In case that the credible data layer does not reach the reference scale, the first node device is configured to preferentially acquire the first data from the credible data layer, and in case of insufficient data size of the acquired first data or that the diversity of the acquired first data does not meet the verification condition, the first data is acquired from other data sources or other data sources with high weights, so as to ensure that data verification can be carried out based on multi-dimensional data in multiple fields at different time windows, and it is guaranteed that the data verification result is reliable.

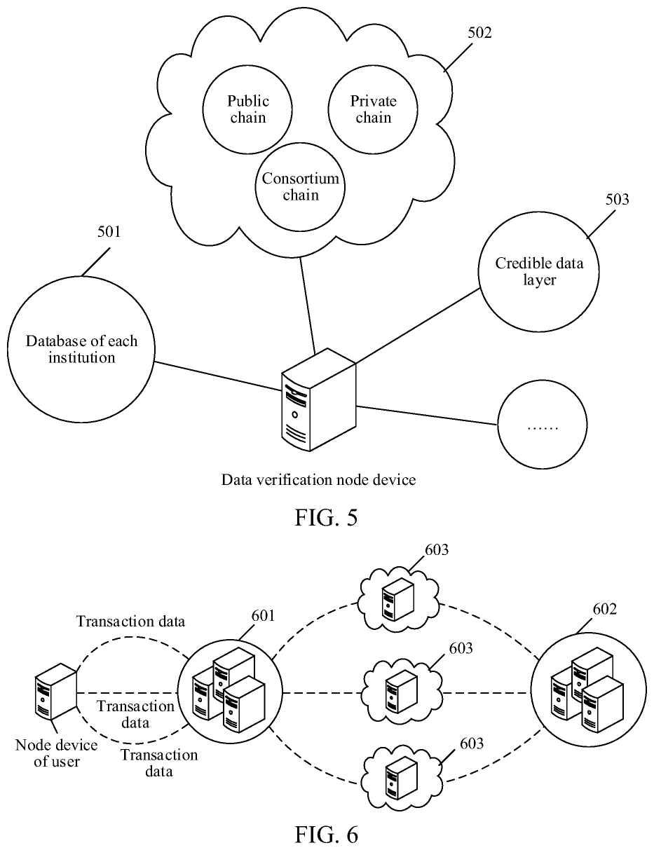

FIG. 5 is a schematic diagram of a data source according to some embodiments. As shown in FIG. 5, a data verification node device, namely the first node device, acquires data from databases 501, block chains 502 and credible data layers 503 of various institutions for data verification. In some embodiments, it is shown as that the confidence of the databases of all the institutions <the confidence of the block chains <the confidence of the credible data layers, and therefore the data verification node device in more fields can adopt the data in the credible data layers for data verification.

In some embodiments, the target storage space is at least one block belonging to the same block chain, or the target storage space is at least one block belonging to different block chains, or the target storage space is at least one database of a non-block chain system, or the target storage space is a storage space formed by combining blocks and databases, and this embodiment of this application has no limit on this.

In some embodiments, the target data and the confidence are directly associated and stored in the target storage space, or the target data and the confidence are stored in the target storage space in a hash value form, and this embodiment of this application has no limit on this. In this embodiment of this application, the data storage process is explained by taking the storage of the target data and the confidence in the form of the first node device, namely the block, as an example.

In some embodiments, the first node device is configured to acquire the block with the highest block height in the block chain as a previous block, generate block head features of the previous block based on all information in the previous block, and perform feature value computing on the target data to be stored in the new block and the data of the confidence to obtain a block body feature value of the new block; and the first node device is configured to store the block head feature value of the previous block and the block body feature value of the new block to the block head of the new block, and store the target data, the confidence and other data to the block body of the new block, so as to generate the new block. After the new block achieves common consensus, the first node device adds the new block to the tail of the block chain, thus the previous block and the new block can be associated through the block head feature value of the previous block. The blocks are connected in series in the block chain, the next block is configured to verify whether the previous block is correct or not, thus the data is prevented from being tampered. The description of storing the data in the block chain is an exemplary description, and the embodiments are not limited as to which method is specifically adopted to store the data in the block chain.

In some embodiments, the first node device is capable of adding a pointer to the new block, and the pointer points to at least one reference block; data stored in the reference block has a target association relationship with the target data, namely, a relationship is established for related data based on the pointer, thus verification loops with different dimensions and different credibility are formed, and moreover, a multi-dimensional interconnected verification storage structure is formed. In the multi-dimensional interconnected verification storage structure, the credibility data layer and the distributed account book data form an interactive structure, multi-party verification storage can realize mutual verification, thus the credibility of the data can be further guaranteed, and a reliable measurement mechanism can be established and applied to various production and life links.

The embodiment introduces a process of performing real-time verification on the target data based on the data in the block chain or the database by the first node device in response to receiving the data acquisition request. In some embodiments, the data verification further includes a non-real-time verification process, that is, in response to receiving the data verification request, the first node device performs real-time verification on the target data, and then performs non-real-time verification on the target data after a period of time is delayed, or the first node device performs non-real-time verification on the target data, this embodiment of this application has no limit on this.

In some embodiments, in response to detecting related newly added data, the first node device is capable of verifying the target data. The first node device is capable of detecting newly added data in the at least one data source, in response to detecting that second data is newly added into the at least one data source, acquiring the second data, and verifying the target data based on the second data. A target association relationship is included between the second data and the target data. The first node device is capable of detecting the newly added data in real time, or detecting the newly added data according to a period, and this embodiment of this application has no limit on this. In case of newly added data, the target data is verified based on the newly added data, non-real-time verification can be achieved based on the newly added data, and therefore the effect of verification based on the multi-dimensional data is achieved, and the verification accuracy is improved.

In some embodiments, the first node device is capable of determining which newly added data is the second data based on the smart contract. That is, the data type, the dimension, the index information and the like of the second data are defined by the smart contract. For example, in a product production scene, the purchase of raw materials and the production activity have a close association relationship; verification of data of the raw material purchase link is taken as an example, the target data is payment data of a production institution for purchasing raw materials; during this payment operation, the fund data of the production institution, production data of the previous year and the like are acquired, and real-time verification is carried out on the payment data; during producing products with the raw materials, production data will be generated, in response to the first node device detecting new production data, and the new production data is associated with the raw materials, the first node device performs non-real-time verification on the payment data, namely verification on the target data from the product production dimension, and the production data includes index information of the raw materials, a serial number of the payment data and the like. In some embodiments, the first node device can also be capable of verifying the payment data of the raw materials, namely the target data, in combination with the data of the product sales dimension.

In some embodiments, the first node device is capable of determining a target moment for carrying out non-real-time verification on the target data, and then verifying the target data based on the newly added data after reaching the target moment. The first node device is capable of determining a target moment based on a receiving moment of the data verification request, and the target moment and the receiving moment are separated by a reference time duration, and in response to reaching the target moment, the first node device is capable of acquiring third data from data newly added within the reference time duration and verifying the target data based on the third data. A target association relationship is included between the third data and the target data. The reference time duration is set by a developer, and this embodiment of this application has no limit on this.

In some embodiments, the reference time duration is stored in the smart contract, and in response to reaching the target moment, the first node device triggers the smart contract to obtain the third data for data verification.

For example, in a supply chain scene, there are situations that a contract is signed at first and then products are delivered, the contract includes a product delivery moment, and the time duration between the product delivery moment and the current moment is determined as a delay period. In response to the target moment after reaching the delay, namely reaching the product delivery moment, the first receiving device is capable of acquiring the third data from the data newly added during the delay period, and the third data includes product delivery data and the like; and the first node device verifies the pre-signed contract data based on the third data to ensure whether the contract is normally carried out or not.

In some embodiments, non-real-time data verification can be continued until the whole production period of the product is finished, or, continued to the end of the life cycle of the product so as to verify the target data based on the data of each link in production and the multi-dimensional data in the lifecycle of the product, and multi-dimensional verification loops are formed, the verification storage of the verification loops achieves mutual verification, thus the interconnected verification storage with higher complexity is formed, and as a result, a more credible verification relationship network is formed.

According to the technical solution provided by this embodiment of this application, the stored associated data from a plurality of fields is subjected to mutual verification in the same or different time windows, for example, the authenticity of payment data, tax data, supply chain data, production associated data and contract data can be mutually verified. The verification process is divided into real-time verification and non-real-time verification; in the real-time verification process and the non-real-time verification process, multi-dimensional verification loops can be formed based on different dimensions of the applied data, and new verification loops can be formed by the verification storage formed by real-time verification and the verification storage formed by non-real-time verification. Based on the accumulated verification storage acquired in the above-mentioned data verification solution, a credibility evaluation index of data verification can be formed. In some embodiments, the plurality of verification storage can form an interconnected verification storage, and the interconnected verification storage refers to verification storage with an association relationship in a natural dimension and a human production and life dimension, such as the verification storage associated in the natural dimensions like space, time and physical and chemical reactions, and verification storage associated in the production and life dimension like a context relationship, a supply chain relationship, an identity relationship, a sovereignty relationship, an education relationship and a tax relationship. In case that the multi-party verification storages form the interconnected verification storage, namely, the verification results acquired based on the multi-dimensional data can be mutually verified, the interconnected verification storages can form an interconnected verification storage with more complex structure, and thus a more reliable data verification mode is formed. The multi-dimensional interconnected verification storage structure formed by the interconnected verification storage can further guarantee the data credibility and form a reliable measurement mechanism, and a large amount of credible data can construct a credible data layer which forms a complementary structure with the distributed account book data. The data with different credible dimensions are formed based on multi-dimensional data verification, joint verification is carried out based on the data with different credible dimensions, and results of credibility at different levels or counterfeiting can be acquired.

In some embodiments, a multi-dimensional data plane is formed through verification storage interconnection, namely mutual verification of multi-dimensional data, so that the data verification stored in the data storage spaces such as the block chain is credible, available, non-ambiguous and complete. Moreover, based on the credible data layer, the stored data can be filtered, and the junk data is filtered out, so that the spatial redundancy of the account book data is reduced, and the data storage energy consumption and the consensus energy consumption are reduced to the maximum extent.

The data verification method is explained as follows by taking the application of this solution in the payment field and the tax field as an example. FIG. 6 is a schematic diagram of a data verification method in the payment field and the tax field according to some embodiments. As shown in FIG. 6, the payment field and the tax field includes a plurality of node devices for data verification; for example, the payment field includes a third node device 601 for data verification, the tax field includes a core verification node, namely a fourth node device 602, the fourth node device 602 is a node device of the tax institution, and the fourth device 602 includes fifth node devices 603 of a plurality of branch institutions.

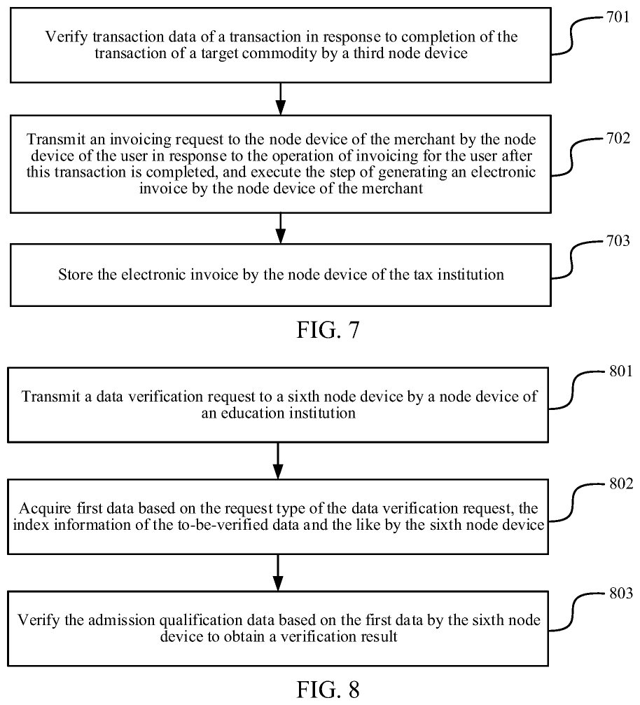

FIG. 7 is a flowchart of data verification in the payment field and the tax field according to some embodiments. As shown in FIG. 7, in some embodiments, in the payment field and the tax field, the data verification process includes the following operations:

701. Verify transaction data of a transaction in response to completion of the transaction of a target commodity by a third node device.

For example, in case that a user purchases a commodity from a certain merchant, the transaction data is generated, and the transaction data include payment data and the like.

In some embodiments, the process of performing data verification by the third node device includes the following operations:

Operation 1. Transmit a data verification request to the third node device 601 in the payment field by the node device of the merchant or the user in response to the completion of the transaction. The data verification request includes transaction data of this transaction.

Operation 2. Acquire first data having a target association relationship with the transaction data from at least one data source by the third node device 601 in response to the data verification request, and verify the transaction data based on the first data.

The at least one data source includes a data source in the payment field or a data source in other production and life fields, such as a data source corresponding to the supply chain for producing the commodity, but is not limited thereto.

In some embodiments, the transaction data includes an order serial number, index information of the product, index information of the user, index information of the merchant and the like; and the third node device is capable of acquiring data of a user dimension, a merchant dimension and a product production dimension based on the transaction data as the first data and verifying payment data of this transaction based on the multi-dimensional first data.

In some embodiments, after the third node device acquires a verification result, the verification result is stored. The third node device is capable of synchronizing the verification result to the node device of the user and the node device of the merchant, or synchronizing the verification result to the node device of the tax field, so that in case that the merchant pays tax, the node device of the tax institution can verify the business data of the merchant.

702. Transmit an invoicing request to the node device of the merchant by the node device of the user in response to the operation of invoicing for the user after this transaction is completed, and execute the step of generating an electronic invoice by the node device of the merchant.

In some embodiments, in an invoicing scene, the node device of the user transmits an invoicing request to the node device of the merchant in response to the operation of invoicing for the user, and the node device of the merchant directly generates the electronic invoice of this transaction in response to the invoicing request and after determining that the payment data corresponding to the invoice to be issued has passed the verification.

In some embodiments, the node device in the tax field is capable of verifying the transaction data such as payment data of this transaction, and notifying the node device of the merchant to execute an invoicing step after the data verification is passed. The node device of the merchant transmits a data verification request to the node device in the tax field in response to the invoicing request; the data verification request is transmitted to the fifth node device 603 of a branch institution in the tax field, and the data verification request includes payment data, the index information of the merchant, the index information of the user and the like; the node device 603 of each branch institution performs data verification based on the data verification request, transmits a data verification result to the node device of the merchant; and the node device of the merchant executes an invoicing step in response to each received verification result indicating that the verification is passed.

703. Store the electronic invoice by the node device of the tax institution.

In some embodiments, the node device of the merchant transmits the electronic invoice to the node device of the user as well as the node device of the tax institution for storing, so that the tax institution can monitor the whole process of invoicing, transferring and reimbursement, and tax payment data of the merchant can be verified in the subsequent tax payment process.

In some embodiments, the electronic invoice is verified by the node device of the tax institution. The tax institution is an issuer of the invoice, and the invoice issued by the tax institution carries an electronic signature of the tax institution. The tax institution can verify the digital signature carried by the electronic invoice to determine the authenticity of the electronic invoice. This embodiment of this application has no limit on the specific method for verifying the electronic invoice by the node device of the tax institution.

For example, in a scene that a merchant pays tax, the node device of the tax institution transmits a data verification request to the fifth node device 603 of the branch institution in response to reaching the tax payment time, or in response to receiving a tax payment request of the merchant; the data verification request includes business data and the like of the merchant in a tax payment period, each fifth node device 603 performs data verification, the verification result is stored and then transmitted to the node device of the tax institution; the tax institution will determine the authenticity of the tax data of the merchant based on each verification result, and determine the tax payment amount of the merchant and the like. Certainly, the node device or the core verification node, namely the fourth node device 602, of the tax institution can also perform data verification again based on the verification result generated by the fifth node device 603, but is not limited thereto.

The technical solution provided by this application is applied to the payment field and the tax field. Data verification can be performed based on multi-dimensional data in different fields and at different time periods such as user personal dimension data, business data of merchant dimension and production data of product dimension, thus a data verification mode independent of spatial data repeatability is formed; and in this verification mode, the association relationship of data in the production and life fields can be fully utilized, online data and actual production and life are closely associated, and the authenticity of the data is verified from the perspective of actual production and life.

The data verification method is explained as follows by taking the application of this solution in the education field as an example. In an admission application scene, the node device is capable of verifying the admission qualification data provided by a student, so as to determine whether the student has the admission qualification or not. FIG. 8 is a flowchart of data verification in the education field provided by an embodiment of this application. As shown in FIG. 8, the data verification process includes the following operations:

801. Transmit a data verification request to a sixth node device by a node device of an education institution.

A node device of a student transmits an admission request to the node device of the education institution, and the node device of the education institution transmits the data verification request to a node device for data verification in the education field, namely the sixth node device in response to the admission request. The admission request includes admission qualification data provided by the student.

802. Acquire first data based on the request type of the data verification request, the index information of the to-be-verified data and the like by the sixth node device.

The request is an admission application type request, and the index information of the to-be-verified data is the certificate number, the student number and the like of the student. The sixth node device is capable of determining information such as a data acquisition range and a data acquisition time range based on the request type, and acquiring the first data associated with the index information of the to-be-verified data from the data included in the data acquisition range, and the data acquisition range includes a data acquisition field and dimensions. For example, the sixth node device acquires the data including the certificate number of the student as the first data, and acquires the data of family members of the student as the first data.

803. Verify the admission qualification data based on the first data by the sixth node device to obtain a verification result.

In some embodiments, the sixth node device is capable of performing real-time data verification based on the acquired first data, and transmitting the data verification result to the node device of the education institution, and the node device of the education institution is capable of determining the admission qualification of the student based on the admission qualification data of the student and the data verification result.

In some embodiments, the sixth node device can also be capable of performing non-real-time data verification. For example, in some scenes, the student submits a next-stage admission application to the education institution in the middle of the fourth term, the education institution audits the admission qualification data currently submitted by the student and also audits test data of the student at the end of the fourth term, and under the condition, non-real-time data verification needs to be carried out. In response to reaching the end of the term or in response to detecting newly added test data of the student in the data source, the sixth node device reacquires the first data and verifies the new test data. The sixth node device is capable of updating the stored verification result based on the verification result of the new test data, so that the timeliness of the verification result is ensured.

In case that the node device of the education institution has the data verification function, data verification can also be carried out by the node device of the education institution. The education institution corresponds to a plurality of node devices, including node devices used for processing the admission request and node devices used for carrying out data verification; and the node devices used for processing the admission request generate the data verification request in response to receiving the admission request and transmit the data verification request to the node devices used for carrying out data verification.

By combining the data verification solution provided by this embodiment of this application with the education field, the authenticity and effectiveness of the data of the admission qualification can be ensured, the situation of counterfeiting of the data of the admission qualification is avoided, and the verification efficiency of the data of the admission qualification and the accuracy of the verification result are effectively improved.

All the foregoing optional technical solutions may be arbitrarily combined to form an optional embodiment of this application, and details are not described herein again.

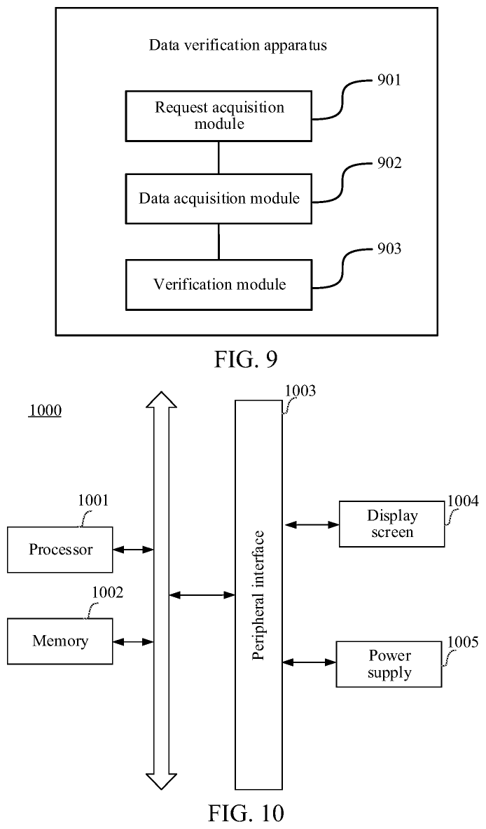

FIG. 9 is a schematic structural diagram of a data verification apparatus according to some embodiments. As shown in FIG. 9, the apparatus includes:

a request acquisition module 901, configured to acquire a data verification request, the data verification request including target data;

a data acquisition module 902, configured to acquire at least one set of first data from at least one data source, the at least one set of first data and the target data having a target association relationship, and the at least one set of first data and the target data being data with different dimensions; and

a verification module 903, configured to verify the target data based on the at least one set of first data.

In some embodiments, the data acquisition module 902 may be configured to:

acquire the at least one set of first data based on a smart contract indicated by a contract identifier in response to the data verification request including the contract identifier; the smart contract is used for providing an association relationship between the target data and the first data.

In some embodiments, the data acquisition module 902 may be configured to:

acquire a request type of the data verification request and index information of the target data in response to the data verification request not including a contract identifier; and

acquire the at least one set of first data based on the request type and a smart contract corresponding to the index information.

In some embodiments, the apparatus may further include:

a detection module, configured to detect newly added data in the at least one data source;

the data acquisition module 902, further configured to acquire, in response to detecting that second data is newly added into the at least one data source, the second data and the target data having a target association relationship; and

the verification module 903, further configured to verify the target data based on the second data.

In some embodiments, the apparatus may further include:

a moment determination module, configured to determine a target moment based on a receiving moment of the data verification request, the target moment and the receiving moment being separated by a reference time duration;

the data acquisition module 902, further configured to acquire third data from data newly added within the reference time duration in response to reaching the target moment, the third data and the target data having a target association relationship; and

the verification module 903, configured to verify the target data based on the third data.

In some embodiments, the verification module 903 may be configured to:

determine a confidence of the target data based on the at least one set of first data.

In some embodiments, the verification module 903 includes:

a result acquisition sub-module, configured to acquire a verification result corresponding to the at least one set of first data;

a first determination sub-module, configured to determine a weight of the at least one set of first data; and

a second determination sub-module, configured to determine the confidence of the target data based on the verification result corresponding to the at least one set of first data and the weight of the at least one set of first data.

In some embodiments, the first determination sub-module may be configured to:

acquire a weight associated with the at least one set of first data from the at least one data source.

In some embodiments, the first determination sub-module is configured to:

acquire a weight of the data source to which the at least one set of first data belongs; and determine the weight of the at least one set of first data based on the weight of the data source.

In some embodiments, the first determination sub-module is configured to:

acquire a first weight associated with the at least one set of first data from the at least one data source, and acquire a second weight of the data source to which the at least one set of first data belongs; and determine the weight of the at least one set of first data based on the first weight and the second weight.

In some embodiments, the apparatus further includes:

a storage module, configured to store the target data and the confidence to a target storage space in response to the confidence being greater than a reference threshold, the target storage space being configured to store data with a weight greater than the reference threshold in the at least one data source.

In some embodiments, the apparatus further includes:

a risk determination module, configured to determine a risk level of the target data based on the confidence of the target data; and

a first transmitting module, configured to transmit prompt information corresponding to the risk level to an initiator of the data verification request.

In some embodiments, the apparatus may further include:

a priority determination module, configured to determine a use priority corresponding to the target data based on the confidence of the target data, the confidence being in positive correlation with the use priority; and

a second transmitting module, configured to transmit the use priority corresponding to the target data to an initiator of the data verification request.

According to the apparatus of some embodiments, by acquiring data having a production and life relationship with the target data, such as data generated by upstream and downstream production links of the target data and these pieces of the data coming from different dimensions, during data verification, the authenticity of the target data can be verified based on different dimensions and different production and life links, so the data in the storage space has credibility and availability.

When the data verification apparatus provided in the foregoing embodiment performs data verification, only divisions of the foregoing functional modules are described by using an example. During actual application, the foregoing functions may be allocated to and completed by different functional modules according to requirements, that is, the internal structure of the apparatus is divided into different functional modules, to complete all or some of the foregoing described functions. In addition, the data verification apparatus and data verification method embodiments provided in the foregoing embodiments belong to one conception. For the specific implementation process, refer to the method embodiments, and details are not described herein again.

The node devices provided in the above technical solution can be realized as a terminal or a server, for example, FIG. 10 is a schematic structural diagram of a terminal provided by an embodiment of this application. The terminal 1000 may be a smartphone, a tablet computer, a moving picture experts group audio layer III (MP3) player, a moving picture experts group audio layer IV (MP4) player, a notebook computer, or a desktop computer. The terminal 1000 may also be referred to as user equipment, a portable terminal, a laptop terminal, a desktop terminal, or by another name.

Generally, the terminal 1000 includes one or more processors 1001 or one or more memories 1002.

The processor 1001 may include one or more processing cores, and may be, for example, a 4-core processor or a 10-core processor. The processor 1001 may be implemented by using at least one hardware form of a digital signal processor (DSP), a field-programmable gate array (FPGA), and a programmable logic array (PLA). The processor 1001 may also include a main processor and a co-processor. The main processor is a processor for processing data in a wake-up state, also referred to as a central processing unit (CPU). The coprocessor is a low-power processor configured to process data in a standby state. In some embodiments, the processor 1001 may be integrated with a graphics processing unit (GPU) that is responsible for rendering and drawing content needing to be displayed by a display screen. In some embodiments, the processor 1001 may further include an artificial intelligence (AI) processor. The AI processor is configured to process computing operations related to machine learning.

The memory 1002 may include one or more computer-readable storage media that may be non-transitory. The memory 1002 may further include a high-speed random access memory and a nonvolatile memory, for example, one or more disk storage devices or flash storage devices. In some embodiments, a non-transitory computer-readable storage medium in the memory 1002 is configured to store at least one piece of program code, the at least one piece of program code being configured to be executed by the processor 1001 to implement the following operations.

acquiring a data verification request, the data verification request including target data;

acquiring at least one set of first data from at least one data source, the at least one set of first data and the target data having a target association relationship, and the at least one set of first data and the target data being data with different dimensions; and

verifying the target data based on the at least one set of first data.

In some embodiments, the acquiring at least one set of first data from at least one data source may include:

acquiring the at least one set of first data based on a smart contract indicated by a contract identifier in response to the data verification request including the contract identifier, the smart contract being used for providing an association relationship between the target data and the first data.

In some embodiments, the acquiring at least one set of first data from at least one data source may include:

acquiring a request type of the data verification request and index information of the target data in response to the data verification request not including a contract identifier; and

acquiring the at least one set of first data based on the request type and a smart contract corresponding to the index information.

In some embodiments, after the verifying the target data based on the at least one set of the first data, the method may further include:

detecting newly added data in the at least one data source;

in response to detecting that second data is newly added into the at least one data source, acquiring the second data, the second data and the target data having a target association relationship; and

verifying the target data based on the second data.

In some embodiments, after the verifying the target data based on the at least one set of the first data, the method may further include:

determining a target moment based on a receiving moment of the data verification request, the target moment and the receiving moment being separated by a reference time duration;

acquiring third data from data newly added within the reference time duration in response to reaching the target moment, the third data and the target data having a target association relationship; and

verifying the target data based on the third data.

In some embodiments, the verifying the target data based on the at least one set of first data may include:

determining a confidence of the target data based on the at least one set of first data.

In some embodiments, the determining a confidence of the target data may include:

acquiring a verification result corresponding to the at least one set of first data;

determining a weight of the at least one set of first data; and

determining the confidence of the target data based on the verification result corresponding to the at least one set of first data and the weight of the at least one set of first data.

In some embodiments, the determining a weight of the at least one set of first data may include:

acquiring a weight associated with the at least one set of first data from the at least one data source.

In some embodiments, the determining a weight of the at least one set of first data may include:

acquiring a weight of the data source to which the at least one set of first data belongs; and

determining the weight of the at least one set of first data based on the weight of the data source.

In some embodiments, the determining a weight of the at least one set of first data may include:

acquiring a first weight associated with the at least one set of first data from the at least one data source, and acquire a second weight of the data source to which the at least one set of first data belongs; and

determining the weight of the at least one set of first data based on the first weight and the second weight.

In some embodiments, after the determining a confidence of the target data based on the at least one set of first data, the method may further include:

storing the target data and the confidence to a target storage space in response to the confidence being greater than a reference threshold, the target storage space being configured to store data with a weight greater than the reference threshold in the at least one data source.

In some embodiments, after the determining a confidence of the target data based on the at least one set of first data, the method may further include:

determining a risk level of the target data based on the confidence of the target data;

and

transmitting prompt information corresponding to the risk level to an initiator of the data verification request.

In some embodiments, after the determining a confidence of the target data based on the at least one set of first data, the method may further include:

determining a use priority corresponding to the target data based on the confidence of the target data, the confidence being in positive correlation with the use priority; and

transmitting the use priority corresponding to the target data to an initiator of the data verification request.

In some embodiments, the terminal 1000 may include a peripheral interface 1003 and at least one peripheral. The processor 1001, the memory 1002, and the peripheral interface 1003 may be connected by using a bus or a signal cable. Each peripheral may be connected to the peripheral interface 1003 by using a bus, a signal cable, or a circuit board. Specifically, the peripheral device includes: a display screen 1004, and a power supply 1005.

The peripheral interface 1003 may be configured to connect the at least one peripheral related to input/output (I/O) to the processor 1001 and the memory 1002. In some embodiments, the processor 1001, the memory 1002 and the peripheral interface 1003 are integrated on the same chip or circuit board. In some other embodiments, any or both of the processor 1001, the memory 1002, and the peripheral interface 1003 may be implemented on an independent chip or circuit board, which is not limited in this embodiment.

The display screen 1004 is configured to display a user interface (UI). The UI may include a graph, a text, an icon, a video, and any combination thereof. When the display screen 1004 is a touch display screen, the display screen 1004 is further capable of collecting touch signals on or above a surface of the display screen 1004. The touch signal may be inputted, as a control signal, to the processor 1001 for processing. In this case, the display screen 1005 may be further configured to provide a virtual button and/or a virtual keyboard, also referred to as a soft button and/or a soft keyboard. In some embodiments, there may be one display screen 1004 arranged on a front panel of the terminal 1000. In some other embodiments, there may be two display screens 1004 respectively arranged on different surfaces of the terminal 1000 or in a folded design. In some embodiments, the display screen 1005 may be a flexible display screen disposed on a curved surface or a folded surface of the terminal 1000. Even, the display screen 1004 may also be set to a non-rectangular irregular pattern, that is, a special-shaped screen. The display screen 1004 may be made of a material such as a liquid crystal display (LCD) or an organic light-emitting diode (OLED).

The power supply 1005 is configured to supply power to components in the terminal 1000. The power supply 1005 may be an alternating-current power supply, a direct-current power supply, a disposable battery, or a rechargeable battery. When the power supply 1005 includes a rechargeable battery, the rechargeable battery may be a wired rechargeable battery or a wireless rechargeable battery. The rechargeable battery may be further configured to support a fast charge technology.

A person skilled in the art may understand that the structure shown in FIG. 10 does not constitute a limitation on the terminal 1000 and that the terminal 1000 may include more or fewer assemblies than those shown in the figure, a combination of some assemblies, or different assembly arrangements.

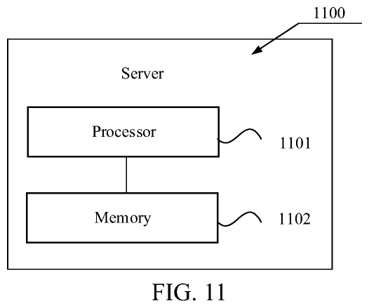

FIG. 11 is a schematic structural diagram of a server according to some embodiments. The server 1100 may vary greatly because a configuration or performance varies, and may include one or more central processing units (CPU) 1101 and one or more memories 1102. The one or more memories 1102 store at least one piece of program code, and the at least one piece of program code is loaded and executed by the one or more processors 1101 to implement the data verification methods provided in the foregoing various method embodiments. Certainly, the server 1100 may also have a wired or wireless network interface, a keyboard, an input/output interface and other components to facilitate input/output. The server 1100 may also include other components for implementing device functions. Details are not described herein.

In some embodiments, a computer-readable storage medium, for example, a memory including at least one piece of program code is further provided. The at least one piece of program code may be executed by a processor to implement the data verification method in the foregoing embodiments. For example, the computer-readable storage medium may be a read-only memory (ROM), a random access memory (RAM), a compact disc ROM (CD-ROM), a magnetic tape, a floppy disk, an optical data storage device, or the like.

In some embodiments, a computer program product is provided, the computer program product including computer instructions, the computer instructions being stored in a computer-readable storage medium. A processor of a computer device reads the computer instructions from the computer-readable storage medium and executes the computer instructions to cause the computer device to perform the data verification method.

A person of ordinary skill in the art may understand that all or some of the operations of the foregoing embodiments may be implemented by hardware, or software, or may be implemented by a program instructing relevant hardware. The program may be stored in a computer-readable storage medium. The storage medium may be a read-only memory, a magnetic disk, an optical disc, or the like.

The foregoing descriptions are merely optional embodiments of the disclosure, but are not intended be limiting. Any modification, equivalent replacement, or improvement made within the spirit and principle of the disclosure shall fall within the protection scope of the disclosure.

What is claimed is:

1. A data verification method, performed by a computer device, the method comprising:
acquiring a data verification request, the data verification request comprising target data;
acquiring at least one set of first data from at least one data source, the at least one set of first data and the target data having a target association relationship, and the at least one set of first data and the target data being data with different dimensions; and
verifying the target data based on the at least one set of first data.

2. The data verification method according to claim 1, wherein the acquiring at least one set of first data comprises:
acquiring the at least one set of first data based on a smart contract indicated by a contract identifier in response to the data verification request comprising the contract identifier, the smart contract being used for providing an association relationship between the target data and the at least one set of first data.

3. The data verification method according to claim 1, wherein the acquiring at least one set of first data from at least one data source comprises:
acquiring a request type of the data verification request and index information of the target data in response to the data verification request not comprising a contract identifier; and
acquiring the at least one set of first data based on the request type and a smart contract corresponding to the index information.

4. The data verification method according to claim 1, wherein after the verifying the method further comprises:
detecting newly added data in the at least one data source;
in response to detecting that second data is newly added into the at least one data source, acquiring the second data, the second data and the target data having the target association relationship; and
verifying the target data based on the second data.

5. The data verification method according to claim 1, wherein after the verifying the method further comprises:
determining a target moment based on a receiving moment of the data verification request, the target moment and the receiving moment being separated by a reference time duration;
acquiring third data from data newly added within the reference time duration in response to reaching the target moment, the third data and the target data having a target association relationship; and
verifying the target data based on the third data.

6. The data verification method according to claim 1, wherein the verifying comprises:
determining a confidence of the target data based on the at least one set of first data.

7. The data verification method according to claim 6, wherein the determining comprises:
acquiring a verification result corresponding to the at least one set of first data;
determining a weight of the at least one set of first data; and
determining the confidence of the target data based on the verification result corresponding to the at least one set of first data and the weight of the at least one set of first data.

8. The data verification method according to claim 7, wherein the determining a weight of the at least one set of first data comprises:
acquiring a weight associated with the at least one set of first data from the at least one data source.

9. The data verification method according to claim 7, wherein the determining a weight of the at least one set of first data comprises:
acquiring a weight of the data source to which the at least one set of first data belongs; and
determining the weight of the at least one set of first data based on the weight of the data source.

10. The data verification method according to claim 7, wherein the determining a weight of the at least one set of first data comprises:
acquiring a first weight associated with the at least one set of first data from the at least one data source, and acquiring a second weight of the data source to which the at least one set of first data belongs; and
determining the weight of the at least one set of first data based on the first weight and the second weight.

11. The data verification method according to claim 6, wherein after the determining, the method further comprises:
storing the target data and the confidence to a target storage space in response to the confidence being greater than a reference threshold, the target storage space being configured to store data with a weight greater than the reference threshold in the at least one data source.

12. The data verification method according to claim 6, wherein after the determining, the method further comprises:
determining a risk level of the target data based on the confidence of the target data; and
transmitting prompt information corresponding to the risk level to an initiator of the data verification request.

13. The data verification method according to claim 6, wherein after the determining, the method further comprises:
determining a use priority corresponding to the target data based on the confidence of the target data, the confidence being in positive correlation with the use priority; and
transmitting the use priority corresponding to the target data to an initiator of the data verification request.

14. A data verification apparatus, comprising:
at least one memory configured to store program code; and
at least one processor configured to read the program code and operate as instructed by the program code, the program code comprising:
request acquisition code configured to cause the at least one processor to acquire a data verification request, the data verification request comprising target data;
data acquisition code configured to cause the at least one processor to acquire at least one set of first data from at least one data source, the at least one set of first data and the target data having a target association relationship, and the at least one set of first data and the target data being data with different dimensions; and
verification code configured to cause the at least one processor to verify the target data based on the at least one set of first data.

15. The data verification apparatus according to claim 14, wherein the data acquisition code is further configured to cause the at least one processor to acquire the at least one set of first data based on a smart contract indicated by a contract identifier in response to the data verification request including the contract identifier, the smart contract is used for providing an association relationship between the target data and the first data.

16. The data verification apparatus according to claim 14, wherein the data acquisition code is further configured to cause the at least one processor to:
acquire a request type of the data verification request and index information of the target data in response to the data verification request not including a contract identifier; and
acquire the at least one set of first data based on the request type and a smart contract corresponding to the index information.

17. The data verification apparatus according to claim 14, wherein
the program code further comprises detection code configured to cause the at least one processor to detect newly added data in the at least one data source;
the data acquisition code is further configured to cause the at least one processor to acquire, in response to detecting that second data is newly added into the at least one data source, the second data and the target data having a target association relationship; and
the verification code is further configured to cause the at least one processor to verify the target data based on the second data.

18. The data verification apparatus according to claim 14, wherein
the program code further comprises moment determination code configured to cause the at least one processor to determine a target moment based on a receiving moment of the data verification request, the target moment and the receiving moment being separate by a reference time duration;
the data acquisition code is further configured to cause the at least one processor to acquire third data from data newly added within the reference time duration in response to reaching the target moment, the third data and the target data having a target association relationship; and
the verification code is further configured to cause the at least one processor to verify the target data based on the third data.

19. The data verification apparatus according to claim 14, wherein the verification code is further configured to cause the at least one processor to determine a confidence of the target data based on the at least one set of first data.

20. A non-transitory computer-readable storage medium, storing computer code that when executed by at least one processor causes the at least one processor to:
acquire a data verification request, the data verification request comprising target data;
acquire at least one set of first data from at least one data source, the at least one set of first data and the target data having a target association relationship, and the at least one set of first data and the target data being data with different dimensions; and
verify the target data based on the at least one set of first data.
